(19) United States
(12) Patent Application Publication
(10) Pub. No.: US 2004/0074447 A1
(43) Pub. Date: Apr. 22, 2004

(54) Methods of reducing incidence of stillborn pigs by using progesterone receptor antagonists

(75) Inventors: Douglas Mann, Terre Haute, IN (US); Paula Gaynor, Sullivan, IN (US)

Correspondence Address: PFIZER INC., PATENT DEPARTMENT, MS8260-1611, EASTERN POINT ROAD, GROTON, CT, 06340, US

(73) Assignee: Pfizer Inc

(21) Appl. No.: 10/668,622

(22) Filed: Sep. 23, 2003

Related U.S. Application Data
(60) Provisional application No. 60/413,249, filed on Sep. 24, 2002.

(51) Int. Cl. A01K 29/00

(52) U.S. Cl. 119/174

(57) ABSTRACT

This invention provides a method for initiation of farrowing of pregnant domestic swine within a predictable number of hours by administering a progesterone receptor antagonist. The present method also significantly reduces reduce stillborn pigs. A preferred progesterone receptor antagonist for use in the present method is RU38,486. The progesterone receptor antagonist can be administered to a pregnant swine via an appropriate route of administration, such as orally, intramuscularly or intravaginally. The present invention greatly facilitates human supervision and assistance during parturition, and is important for the production and profitability of farrowing operation.

### FIELD OF THE INVENTION

This invention relates in general to a method for inducing synchronized onset of parturition and for reducing stillborn pigs in pregnant swine. More particularly, this invention relates to a method for initiation of farrowing of pregnant swine within a predictable number of hours by administering a progesterone receptor antagonist, such as RU-38,486.

### BACKGROUND OF THE INVENTION

Profitability of farrowing operations is a direct function of the number of animals produced per sow per year. Reducing mortality, especially around the time of birth and prior to weaning, improves efficiency of production and profitability. Newborn pigs are very susceptible to hypothermia, hypoglycemia, and being laid on by the sow (1). In addition, sows that give birth to at least one stillborn pig have a 24% greater risk of dying themselves than sows with no stillborn pigs (2).

Induction of parturition creates an opportunity for supervision of more farrowings, thereby reducing the number of pigs born dead (stillborn), decreasing risk of mortality of sows, facilitating cross-fostering of piglets from very large litters to sows with fewer piglets, and decreasing the variability of weaning ages and lactation lengths among a group of animals managed together (3). Piglet survival and vigor are highest when sows are induced to farrow on their due date (1), but are compromised if sows are induced prior to day 113 post-mating or 2 to 3 days after the expected day of parturition (3).

The objective of induction programs for swine is to initiate parturition for the vast majority of treated animals within a time when farrowing barn staff is present. Several pharmacological methods have been used to induce parturition in swine. In the United States, farrowing is most commonly initiated by intramuscular injection of synthetic prostaglandin F 2-alpha (PGF₂α; dinoprost tromethamine, Lutalyse®, or Estrumate). Lutalyse® is currently the only FDA-approved substance for inducing parturition in swine in the USA. Birth of the first pig can occur between 2 and 44 hr later (1, 3). A narrower window for onset of parturition will enable supervision of more farrowings and possibly improve survival of piglets.

Several researchers have investigated the use of PGF₂α followed by varying amounts of oxytocin 18 to 24 hr later in an attempt to synchronize parturition (1, 3). However, doses of oxytocin greater than 20 to 30 IU may induce uterine spasms in some sows. This, in turn, can increase the incidence of stillborn piglets because umbilical cords may be ruptured before piglets are born and able to breathe on their own. For this reason, administration of oxytocin is generally not recommended unless at least one piglet has already been born and the progress of parturition will be constantly monitored after administration.

Administration of progesterone to delay the onset of parturition is not routine because progesterone is not commercially available, nor is progesterone currently approved for this use in any animal species in the United States. However, U.S. Pat. No. 4,870,066 describes the use of progesterone and estrogen to delay and synchronize onset of parturition in swine.

The β-receptor agonist clenbuterol (150 μg) exerts tocolytic (contractile inhibiting) effects on the uterus and delays parturition up to 15 hr when administered to sows in labor (before birth of the first pig). Clenbuterol is a uterine relaxant and can be beneficial in alleviating dystocia (3). One protocol for induction of parturition was to administer 10 mg of PGF₂α at 9:00 AM to initiate parturition, and at 4:00 PM administer 150 μg clenbuterol to sows without any piglets. The following morning, parturition was re-initiated in sows without piglets by administering 10 IU oxytocin and 1.5 mg of carazolol (1).

Epostane is a competitive inhibitor of 3β-hydroxysteroid dehydrogenase. Epostane reportedly decreased peripheral levels of progesterone and induced onset of parturition in swine (3) and sheep (4). The interval from oral administration (5 or 10 mg/kg BW) to birth of the first pig was about 34 hr (3) and to birth of lambs was 33 hr (4). U.S. Pat. No. 4,870,068 describes the use of epostane in inducing parturition in swine.

Induction of parturition in swine using two β-antagonists, propranolol and carazolol, has been reported (5). Carazolol appears to have better efficacy in pigs, but the reason for this is not clear (5). Carazolol is a non-selective 1-antagonist, with somewhat stronger affinity for β1 than β2 receptors (6). The membrane stabilizing potential of carazolol is 13 fold less than that of propranolol, therefore a cardiosuppressive effect should not occur (6). Carazolol lacks intrinsic sympathomimetic activity (6).

Alpha-2 adrenergic receptors may also regulate uterine contractility. The α-₂ agonist xylazine caused dose-dependent increases in porcine myometrial contractility during diestrus, and the α-₂ antagonists idazoxan and yohimbine blocked this effect (7). Uterine contractions are increased by the triterpenoid glycoside dalsaxin, isolated from the root of D. saxatilis (8). This response was enhanced by propranolol, and substantially reduced by atipamezole, a uterine spasmogen (8). It was suggested that dalsaxin enhanced uterine contraction by stimulating post-junctional α-₂ receptors, presumably by inhibiting plasma membrane adenyate cyclase and subsequently, reducing intracellular cAMP (8). U.S. Pat. No. 5,369,128 describes a method for inducing and synchronizing farrowing in swine by administering an effective dose of PGF α-₂ followed by administration of an effective dose of a peripheral α-2 adrenergic agonist.

The anti-progesterone agent RU-38,486 is reportedly extremely effective in enhancing cervical dilation, along with reducing concentrations of progesterone in blood. It has been reported that RU-38,486 administered to pigs at 4 mg/kg body weight on days 111 and 112 post-breeding effectively induced parturition (9). However, it is not clear whether RU-38,486 reduced the number of stillborn pigs. It has also been reported that the ‘cervical dilator’ proquamezine, which is a phenothiazine derivative with smooth muscle relaxing properties, can be administered to pigs intravenously (10). A preparation containing fenpiprane and fenpipramide has also been described (10).

U.S. Pat. No. 4,626,531 describes the use of antigestagens (i.e. antiprogesterones such as RU-38,486) and prostaglandins for induction of labor and abortion in humans. European Patent 446124 describes the preparation and use of antiprogestomimetics for synchronization of parturition in livestock. However, it is unclear whether administration of antiprogestins reduces stillborn pigs.

WO 0054766 A1 describes generally agents and methods for promoting production gains in animals. However, WO 0054766 A1 does not disclose that administration of RU-38,486 reduces stillborns in pregnant swine.

### SUMMARY OF THE INVENTION

The present invention provides a method for initiation of farrowing of pregnant domestic swine within a predictable number of hours. This method involves administration of a progesterone receptor antagonist to pregnant swine. A preferred progesterone receptor antagonist for use in the present method is the compound RU38486.

The progesterone receptor antagonist can be administered in two or more administrations or in a single administration. In a preferred embodiment, a progesterone receptor antagonist is administered to pregnant sows in a single administration of an amount effective to induce farrowing at approximately 20 to 25 hours later and to reduce the number of piglets born dead.

The administration can be achieved via any appropriate route, including an intramuscular, intravaginal or oral route.

### BRIEF DESCRIPTION OF THE DRAWINGS

FIG. 1 is a bar graph showing the percent of animals that farrowed by day of gestation following administration of 4 mg/kg BW CP161,258.

FIG. 2 is a bar graph showing the percent of animals that farrowed by day of gestation following administration of 8 mg/kg BW CP161,258.

### DETAILED DESCRIPTION OF THE INVENTION

The present invention provides a method for initiation of farrowing of pregnant domestic swine within a predictable number of hours by administering a progesterone receptor antagonist.

According to the present invention, administration of a progesterone receptor antagonist effectively initiates endocrine, physiological, and mechanical changes leading to predictable time of onset of farrowing in swine. In accordance with the present invention, a predictable onset of farrowing is about 10 hours to about 24 hours and preferably about 12 to about 22 hours. Without being bound to any particular theory, it is proposed that the changes induced by a progesterone receptor antagonist may include blockade of progesterone receptors on the ovary and uterus, an initial increase in concentrations of progesterone in plasma, followed by a rapid decline as the corpora lutea on the ovary regress, a gradual increase in uterine contractility concurrent with declining concentrations of progesterone in blood, an increase in concentrations of relaxin in blood, and concurrent dilation of the uterine cervix.

In accordance with the present invention, administration of a progesterone receptor antagonist induces a pregnant sow to farrow within a predictable number of hours. In addition, administration of a progesterone receptor antagonist reduces the number of piglets born dead. Thus, the present methods provide an opportunity for convenient human supervision and assistance during parturition, and are important for improving the production and profitability of farrowing operations.

As used herein, “a progesterone receptor antagonist” refers to a compound or agent that inhibits the activity of the progesterone receptor. Progesterone receptor antagonists which can be employed in the present methods include, but are not limited to, 11-(4-Dimethylamino-phenyl)-17-hydroxy-13-methyl-17-prop-1-ynyl-1,2,6,7,8,11,12,13,14,15,16,17-dodecahydro-cyclopenta[a]phenanthren-3-one, available under the designation “RU38486”, “RU486” or “CP161,258” or “Mifepristone”; 11-(4-Acetyl-phenyl)-17-hydroxy-13-methyl-17-(1,1,2,2,2-pentafluoro-ethyl)-1,2,6,7,8,11,12,13,14,15,16,17-dodecahydro-cyclopenta[a]phenanthren-3-one, available under the designation “ZK230211”; 11-(4-Dimethylamino-phenyl)-17-hydroxy-17-(3-hydroxy-propyl)-13-methyl-1,2,6,7,8, 11,12,13,14,15,16,17-dodecahydro-cyclopenta[a]phenanthren-3-one, available under the designation “ZK98299”, also known as onapristone; “ZK98774”; “ZK137316”; 11-(4-Acetyl-phenyl)-17-hydroxy-13-methyl-17-prop-1-ynyl-1,2,6,7,8,11,12,13,14,15,16,17-dodecahydro-cyclopenta[a]phenanthren-3-one, available under the designation “ZK12993”; 4-(17-Methoxy-17-methoxymethyl-13-methyl-3-oxo-2,3,6,7,8,11,12,13,14,15,16,17-dodecahydro-1H-cyclopenta[a]phenanthren-11-yl)-benzaldehyde oxime, available under the designation “J867”; 13-Methyl-7,8,9,11,12,13,14,15,16,17-decahydro-6H-cyclopenta[a]phenanthrene-3,17-diol, available under the designation “J956”; 3-Fluoro-5-(2,2,4-trimethyl-1,2-dihydro-quinolin-6-yl)-benzonitrile, available under the designation “LG-120830”; 1,2-dihydro-2,2,4-trimethyl-6-phenlyquinoline, available under the designation “LGOO1447”; “LG120753”, “0RG33628”; 11-(4-Dimethylamino-phenyl)-17-hydroxy-17-(3-hydroxy-propyl)-13-methyl-1,2,6,7,8,11,12,13,14,15,16,17-dodecahydro-cyclopenta[a]phenanthren-3-one, available under the designation “ZK-98299” or “onapristone”; lilopristone (11-(4-Dimethylamino-phenyl)-17-hydroxy-17-(3-hydroxy-propenyl)-13-methyl-1,2,6,7,8, 11,12,13,14,15,16,17-dodecahydro-cyclopenta[a]phenanthren-3-one), and salts and derivatives or analogs of these compounds which function as a progesterone receptor antagonist.

A preferred progesterone receptor antagonist of the present invention is RU38486. A combination of two or more progesterone receptor antagonists can also be used in the present methods.

According to the present invention, a progesterone receptor antagonist is administered to pregnant swine that are at least 112 days post-mating. The progesterone receptor antagonist can be administered by two or more administrations or by a single administration. For example, a progesterone receptor antagonist can be administered in two administrations in an amount of between about 0.001 and about 15 mg/kg body weight per dose, preferably between about 1 to about 6 mg/kg body weight per dose, more preferably about 4 mg/kg body weight per dose. The first dose can be given at approximately 30-40 hours prior to the desired time of birth of the first piglet, followed by a second dose at approximately 9-15 hours prior to the desired time of birth of the first piglet.

In a preferred embodiment, a progesterone receptor antagonist is administered in a single administration. The single administration can be performed at approximately 20 to 25 hours prior to the desired time of birth of the first piglet. The amount of the antagonist used in a single administration is generally in the range of about 0.001 mg and about 15 mg/kg body weight. Preferably, the antagonist is administered in a single administration of about 0.001 mg/kg body weight to about 15 mg/kg body weight, or more preferably, about 8 mg/kg body weight.

A progesterone receptor antagonist can be administered together with a pharmaceutically acceptable carrier. A pharmaceutically acceptable carrier includes solvents, dispersion media, isotonic agents and the like. The carrier can be liquid, semi-solid, e.g. pastes, or solid carriers. Examples of carriers include oils, water, saline solutions, sugar, gel, lipids, liposomes, resins, porous matrices, binders, fillers, coatings, preservatives and the like, or combinations thereof. Carriers for use in the present method include those materials that allow the slow, sustained release of the progesterone receptor antagonist contained or admixed therein.

Administration of the progesterone receptor can be achieved through various routes, such as via an intramuscular, intravenous, subcutaneous, transdermal, intravaginal, or oral route. Preferred routes of administration are intramuscular, intravaginal or oral route of administration. Administration can be done in a manner suitable to achieve efficient delivery of the receptor antagonist, including injection, implantation, intravaginal insertion of a sustained release device such as a gel, a cream, a paste, or any solid or semi-liquid matrix device (such as Cue-Mate or PRIDs) made of silicone, man-made or synthetic materials, or equivalents, that contain any progesterone receptor antagonist.

The following examples illustrate, but by no means limit, the present invention.

### EXAMPLE 1

Objective

The objectives of this study were to determine the effects of administration of the progesterone receptor antagonist CP161,258 on the concentration of progesterone, the time interval from the 1^{st} administration of test article on day 112 to birth of the 1^{st} pig, the time interval from the 2^{nd} administration of test article to birth of the 1^{st} pig, and the status of piglets at birth (alive, stillborn, mummies).

Experimental Animals

a. Breed/strain: Crossbred first parity gilts

b. Initial weight (upon arrival): Approximately 180-250 kg

c. Sex: Females, approximately 104 days pregnant

c. Origin: Scott Wilson, Prairie View Farms, Wis.

d. Identification: Eartag.

Management

a. Feeding method: pre-partum: ˜3 kg/animal/day, half provided in AM, half in PM. Post-partum: ad-libitum (˜10-20% weighbacks each day).

b. Watering method: ad libitum from nipple waterers.

c. Housing: Farrowing crates in building 608W, inside dimensions-19.5″×6′ 11′.

d. Environmental control: Thermostatically controlled ventilation.

e. Diet: 17% protein corn+soybean meal diet, PL17.

Test Materials

CP161,258, Sigma Chemical Co, 25 mg/ml in sterile water, lots 110K1203 and 30K1542, Expires 06/2002

Design

| | Description | Number of animals |
|---|---|---|
| T1 | Non-medicated control | 10 |
| T2 | Days 112 and 113, 4 mg/kg, orally | 10 |

Procedure

Animals. Twenty pregnant crossbred female swine were purchased and delivered to Terre Haute on approximately day 102-107 of gestation. These animals were placed in farrowing crates in building 608W. Animals assigned to T2 averaged 195 kg BW. Animals (sows and piglets) were euthanized within 48 hr post-farrowing or on day 116 post-mating. There was no estimate of pre-weaning mortality in this study.

Diet. The same feed, PL17, which contained approximately 17% crude protein, was fed throughout. However, the amount fed was limited to approximately 3 kg/animal/day prior to farrowing. Feed was provided ad libitum after farrowing.

Randomization of animals. Animals were ranked according to expected farrowing date and randomly assigned to treatment within blocks of 2 animals each.

Test article administration. Animals assigned to T1 did not receive test article or diluent. For treatment group T2, test article was diluted to a concentration of 25 mg/ml in 50% propylene glycol and water, and stored refrigerated (2-8° C.). Test article was administered orally after the morning blood sample was collected. The volume administered was approximately 30 ml to deliver a dosage of 4 mg/kg BW. Animals were administered with approximately 30 ml of water following administration of test article.

Blood samples. Blood samples were collected from all animals (including T1 and T2) prior to administration of test article at 7:30 am on days 112 and 113. In addition, a PM blood sample was collected beginning at approximately 1:30 pm on days 112 and 113. Additional blood samples were collected at 7:30 am and 1:30 pm on subsequent days (>or =day 114). The final blood sample was collected after farrowing was complete. All blood samples (7 ml) were collected using sodium heparin vacutainers. Samples were refrigerated, centrifuged, and plasma was separated within 2 hr after collection. One aliquot of each sample was sent to Cornell Veterinary Diagnostic Lab for progesterone analyses by RIA.

Early/late farrowing. Animals that started to farrow (i.e. at least one pig born) before administration of test article on day 112 were removed from the study and did not receive any test article. Animals that started to farrow after receiving test article on day 112, but before the time that test article would be administered on day 113 did not receive any additional test article. If animals farrowed before day 114, the final blood sample was collected after farrowing was complete. Animals that did not farrow by the morning of day 116 were assigned a value of 96 hr.

Data/Analyses. Response variables measured in this study were: hours from the time of the 1^{st} dosing on day 112 post-breeding to birth of the 1^{st} pig, hours from the 2^{nd} dosing on day 113 to birth of the 1^{st} pig, number of piglets that were alive at birth (born alive), stillborn (normal appearance term piglet, but dead at time of birth), and mummies (smaller than littermates, decayed at birth). The variables were analyzed using a mixed model analysis (proc mixed, SAS) with block as a random effect and treatment as a fixed effect. Concentrations of progesterone were analyzed using a repeated measure mixed model analysis, with block as a random effect and treatment as a fixed effect.

Results

No adverse behavioral reactions were observed for any of the animals after administration of test article. One animal assigned to T1 (178) did not farrow by day 116 (no piglet data), and one animal assigned to T2 (183) farrowed before receiving test article (removed from all analyses).

The time interval between the dosing on day 112 and the onset of farrowing, the time interval between the dosing on day 113 and the onset of farrowing, and the status of the born piglet are summarized in Table 2. Administration of the progesterone receptor antagonist CP161,258 at a dosage of 4 mg/kg BW on days 112 and 113 of gestation reduced the time interval from the 1^{st} administration of test article to the onset of parturition to half. Administration of CP161,258 also reduced the variation among animals in the amount of time it takes for the pigs to give birth to the 1^{st} piglet.

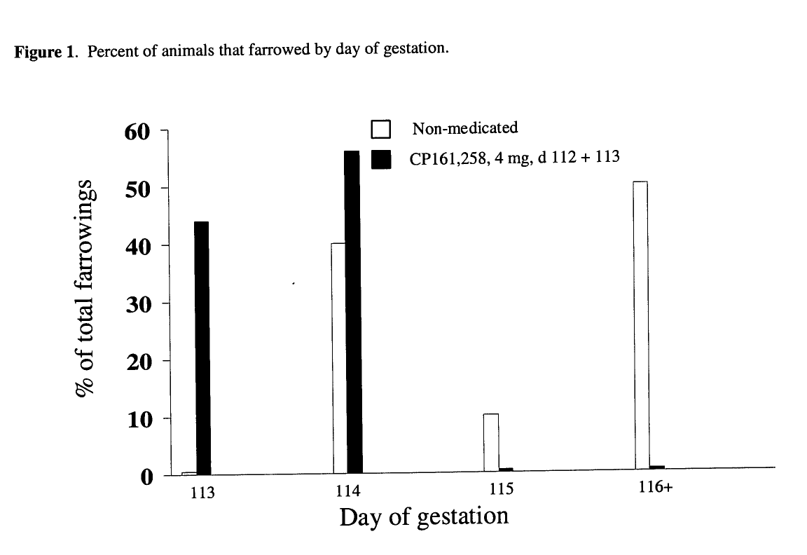

Approximately 40% (4/10) of non-medicated controls farrowed by day 114 (FIG. 1), while the remaining non-medicated animals did not farrow until approximately day 116. In contrast, 45% (4/9) of the animals assigned to treatment group T2 farrowed the day following the first treatment. All the remaining animals (5/9) assigned to T2 farrowed by day 114 (FIG. 1).

The number of piglets born dead (stillborns) was lower for animals treated with CP161,258 (mean=0.1 pigs/litter) than for non-medicated controls (mean=1.0 pigs/litter; Table 1).

Concentrations of progesterone in plasma are summarized in Tables 3 and 4. Concentrations of progesterone in plasma remained higher in the −24 hr period preceding parturition in animals that received CP161,258, as compared to the non-medicated controls. This response is consistent with the hypothesis that the progesterone receptor antagonist blocked the negative feedback regulation of the release of progesterone from the corpora lutea on the ovaries.

Conclusions

CP161,258 induced more synchronous onset of parturition (45% within 1 day, 100% within 2 days) and significantly reduced the number of stillborn piglets (−0.9 pigs/litter). No adverse behavioral effects were observed. Concentrations of progesterone within the 24-hr period preceding parturition were higher in CP161,258 treated animals, as compared to the non-medicated controls.

These data indicate that oral administration of the progesterone receptor antagonist, CP161,258, safely and effectively synchronized parturition, lowered stillbirths and potentially significantly lowered pre-weaning mortality. Pre-weaning mortality was not measured in this study because animals were euthanized within 3 days after parturition.

TABLE 1
Farrowing data by treatment. Number of data
points is in parentheses besides each mean.
(SD = standard deviation; CL = 95% confidence limits)

| | | T2- | | |
|---|---|---|---|---|
| | | 4 mg/kg BW | | Overall |
| | T1- | CP161,258 | Avg. | Treatment |
| | Non-medicated | D 112 + 113 | SE | Effect |
| Hr, 1^{st} dose d 112 | | | | |
| To 1^{st} pig ± SD | 76 ± 26 (10) | 36 ± 15 (9) | 7.0 | P = .0009 |
| Lower/upper CL | 62/91 | 21/52 | | |
| Hr, 2^{nd} dose d 113 | | | | |
| To 1^{st} pig ± SD | 52 ± 26 (10) | 36 ± 15 (9) | 7.0 | P = .12 |
| Lower/upper CL | 38/67 | 21/52 | | |
| Piglet data: | | | | |
| Born alive | 9.8 (9) | 8.9 (9) | 1.1 | P = .58 |
| Stillborn | 1.0 (9) | 0.1* (9) | 0.2 | P = .02 |
| Mummies | 0.2 (9) | 0 (9) | 0.1 | P = .21 |

TABLE 2
Response variables for each animal.

| | | Hours from 1^{st} | | Piglets | |
|---|---|---|---|---|---|
| | | Treatment | Piglets | dead at | |
| | | to | Born | Birth | Mummified |
| Animal | TreatMent | 1^{st} pig | alive | (stillborn) | fetuses |
| 185 | T1 | 47.0 | 8 | 1 | 0 |
| 175 | T1 | 47.4 | 12 | 0 | 0 |
| 180 | T1 | 48.0 | 4 | 2 | 0 |
| 176 | T1 | 54.4 | 10 | 2 | 0 |
| 181 | T1 | 72.0 | 13 | 1 | 1 |
| 189 | T1 | 89.3 | 8 | 2 | 0 |
| 184 | T1 | 94.0 | 15 | 1 | 0 |
| 178 | T1 | 96.0 | . | . | . |
| 193 | T1 | 96.0 | 12 | 0 | 0 |
| 190 | T1 | 120.0 | 6 | 0 | 1 |
| 187 | T2 | 17.3 | 14 | 0 | 0 |
| 179 | T2 | 18.0 | 7 | 1 | 0 |
| 191 | T2 | 23.0 | 12 | 0 | 0 |
| 188 | T2 | 27.3 | 12 | 0 | 0 |
| 192 | T2 | 46.0 | 5 | 0 | 0 |
| 186 | T2 | 47.0 | 9 | 0 | 0 |
| 177 | T2 | 47.4 | 9 | 0 | 0 |
| 182 | T2 | 48.0 | 7 | 0 | 0 |
| 174 | T2 | 54.4 | 5 | 0 | 0 |

TABLE 3
Mean concentrations (ng/ml) of progesterone in plasma by treatment
and time. Number of values used in each mean is in parentheses.
SE (standard error) of differences is between 0.9 and 1.3.

| Sample time | T1 = non-medicated | T2 = CP161,258 |
|---|---|---|
| −4 | 13.3 (7) | 14.2 (2) |
| −3 | 13.0 (9) | 14.5 (5) |
| −2 | 11.6 (9) | 14.0* (8) |
| −1 | 9.7 (9) | 12.3* (9) |
| 0 | 6.2 (9) | 7.5 (9) |
| 1 | 2.3 (9) | 1.5 (9) |

*Means within each row are different at P < .05.

TABLE 4
Concentrations of progesterone in plasma for each animal
at each sample time. (Time = the time when a sample
was taken relative to the time of farrowing; e.g., “time 0”
means that the sample was taken immediately before
farrowing, and “time 1” means that the sample was taken
within 12 hr after farrowing was complete. pfirst = covariate
for the initial concentration of progesterone.
p4 = concentration of procesterone ng/ml in plasma.)

| Obs | animal | trt | time | pfirst | p4 |
|---|---|---|---|---|---|
| 1 | 174 | 2 | −4 | 15.25 | 15.25 |
| 2 | 174 | 2 | −3 | 15.25 | 13.88 |
| 3 | 174 | 2 | −2 | 15.25 | 17.27 |
| 4 | 174 | 2 | −1 | 15.25 | 13.88 |
| 5 | 174 | 2 | 0 | 15.25 | 5.62 |
| 6 | 174 | 2 | 1 | 15.25 | 0.82 |
| 7 | 175 | 1 | −4 | 15.84 | 15.84 |
| 8 | 175 | 1 | −3 | 15.84 | 17.93 |
| 9 | 175 | 1 | −2 | 15.84 | 13.14 |
| 10 | 175 | 1 | −1 | 15.84 | 12.07 |
| 11 | 175 | 1 | 0 | 15.84 | 5.35 |
| 12 | 175 | 1 | 1 | 15.84 | 1.15 |
| 13 | 176 | 1 | −4 | 10.60 | 10.60 |
| 14 | 176 | 1 | −3 | 10.60 | 9.30 |
| 15 | 176 | 1 | −2 | 10.60 | 7.81 |
| 16 | 176 | 1 | −1 | 10.60 | 10.90 |
| 17 | 176 | 1 | 0 | 10.60 | 4.91 |
| 18 | 176 | 1 | 1 | 10.60 | 1.01 |
| 19 | 177 | 2 | −4 | 15.28 | . |
| 20 | 177 | 2 | −3 | 15.28 | 15.28 |
| 21 | 177 | 2 | −2 | 15.28 | 13.89 |
| 22 | 177 | 2 | −1 | 15.28 | 15.46 |
| 23 | 177 | 2 | 0 | 15.28 | 9.45 |
| 24 | 177 | 2 | 1 | 15.28 | 1.62 |
| 25 | 179 | 2 | −4 | 15.47 | . |
| 26 | 179 | 2 | −3 | 15.47 | . |
| 27 | 179 | 2 | −2 | 15.47 | 15.47 |
| 28 | 179 | 2 | −1 | 15.47 | 18.89 |
| 29 | 179 | 2 | 0 | 15.47 | 13.37 |
| 30 | 179 | 2 | 1 | 15.47 | 1.95 |
| 31 | 180 | 1 | −4 | 12.50 | . |
| 32 | 180 | 1 | −3 | 12.50 | 12.50 |
| 33 | 180 | 1 | −2 | 12.50 | 12.25 |
| 34 | 180 | 1 | −1 | 12.50 | 11.66 |
| 35 | 180 | 1 | 0 | 12.50 | 8.14 |
| 36 | 180 | 1 | 1 | 12.50 | 0.46 |
| 37 | 181 | 1 | −4 | 11.21 | 14.11 |
| 38 | 181 | 1 | −3 | 11.21 | 13.03 |
| 39 | 181 | 1 | −2 | 11.21 | 8.93 |
| 40 | 181 | 1 | −1 | 11.21 | 5.48 |
| 41 | 181 | 1 | 0 | 11.21 | 4.89 |
| 42 | 181 | 1 | 1 | 11.21 | 1.01 |
| 43 | 182 | 2 | −4 | 13.49 | 13.49 |
| 44 | 182 | 2 | −3 | 13.49 | 14.66 |
| 45 | 182 | 2 | −2 | 13.49 | 13.96 |
| 46 | 182 | 2 | −1 | 13.49 | 7.63 |
| 47 | 182 | 2 | 0 | 13.49 | 4.95 |
| 48 | 182 | 2 | 1 | 13.49 | 4.50 |
| 49 | 184 | 1 | −4 | 13.30 | 15.57 |
| 50 | 184 | 1 | −3 | 13.30 | 15.24 |
| 51 | 184 | 1 | −2 | 13.30 | 11.69 |
| 52 | 184 | 1 | −1 | 13.30 | 4.80 |
| 53 | 184 | 1 | 0 | 13.30 | 5.47 |
| 54 | 184 | 1 | 1 | 13.30 | 0.92 |
| 55 | 185 | 1 | −4 | 10.43 | . |
| 56 | 185 | 1 | −3 | 10.43 | 10.43 |
| 57 | 185 | 1 | −2 | 10.43 | 8.54 |
| 58 | 185 | 1 | −1 | 10.43 | 6.29 |
| 59 | 185 | 1 | 0 | 10.43 | 4.57 |
| 60 | 185 | 1 | 1 | 10.43 | 1.57 |
| 61 | 186 | 2 | −4 | 16.68 | . |
| 62 | 186 | 2 | −3 | 16.68 | 16.68 |
| 63 | 186 | 2 | −2 | 16.68 | 15.17 |
| 64 | 186 | 2 | −1 | 16.68 | 8.18 |
| 65 | 186 | 2 | 0 | 16.68 | 9.41 |
| 66 | 186 | 2 | 1 | 16.68 | 1.64 |
| 67 | 187 | 2 | −4 | 10.92 | . |
| 68 | 187 | 2 | −3 | 10.92 | . |
| 69 | 187 | 2 | −2 | 10.92 | 10.92 |
| 70 | 187 | 2 | −1 | 10.92 | 10.70 |
| 71 | 187 | 2 | 0 | 10.92 | 5.64 |
| 72 | 187 | 2 | 1 | 10.92 | 1.11 |
| 73 | 188 | 2 | −4 | 17.76 | . |
| 74 | 188 | 2 | −3 | 17.76 | . |
| 75 | 188 | 2 | −2 | 17.76 | 17.76 |
| 76 | 188 | 2 | −1 | 17.76 | 16.70 |
| 77 | 188 | 2 | 0 | 17.76 | 7.17 |
| 78 | 188 | 2 | 1 | 17.76 | 0.79 |
| 79 | 189 | 1 | −4 | 15.53 | 12.81 |
| 80 | 189 | 1 | −3 | 15.53 | 13.26 |
| 81 | 189 | 1 | −2 | 15.53 | 12.62 |
| 82 | 189 | 1 | −1 | 15.53 | 14.13 |
| 83 | 189 | 1 | 0 | 15.53 | 6.87 |
| 84 | 189 | 1 | 1 | 15.53 | 4.82 |
| 85 | 190 | 1 | −4 | 11.56 | 12.08 |
| 86 | 190 | 1 | −3 | 11.56 | 9.77 |
| 87 | 190 | 1 | −2 | 11.56 | 14.07 |
| 88 | 190 | 1 | −1 | 11.56 | 13.73 |
| 89 | 190 | 1 | 0 | 11.56 | 8.54 |
| 90 | 190 | 1 | 1 | 11.56 | 6.73 |
| 91 | 191 | 2 | −4 | 8.27 | . |
| 92 | 191 | 2 | −3 | 8.27 | . |
| 93 | 191 | 2 | −2 | 8.27 | . |
| 94 | 191 | 2 | −1 | 8.27 | 8.27 |
| 95 | 191 | 2 | 0 | 8.27 | 5.76 |
| 96 | 191 | 2 | 1 | 8.27 | 2.05 |
| 97 | 192 | 2 | −4 | 14.93 | . |
| 98 | 192 | 2 | −3 | 14.93 | 14.93 |
| 99 | 192 | 2 | −2 | 14.93 | 12.42 |
| 100 | 192 | 2 | −1 | 14.93 | 13.76 |
| 101 | 192 | 2 | 0 | 14.93 | 8.12 |
| 102 | 192 | 2 | 1 | 14.93 | 1.34 |
| 103 | 193 | 1 | −4 | 14.81 | 11.64 |
| 104 | 193 | 1 | −3 | 14.81 | 12.51 |
| 105 | 193 | 1 | −2 | 14.81 | 12.80 |
| 106 | 193 | 1 | −1 | 14.81 | 5.13 |
| 107 | 193 | 1 | 0 | 14.81 | 4.25 |
| 108 | 193 | 1 | 1 | 14.81 | 2.44 |

### EXAMPLE 2

Objective

The objectives of this study were to confirm the effects of administration of the progesterone receptor antagonist, CP161,258, at a dosage of 4 mg/kg BW on days 112 and 113, to determine the effects of a single administration of CP161,258 at 8 mg/kg BW on day 113, and to determine the effects of administration of porcine relaxin on day 113 on the time interval from the administration to the time of birth of the 1^{st} pig, as well as the status of piglets at birth (alive, stillborn, mummies).

Experimental Animals

a. Breed/strain: Crossbred first parity gilts.

b. Initial weight (upon arrival): Approximately 180-250 kg.

c. Sex: Females, approximately 104 days pregnant.

c. Origin: Scott Wilson, Prairie View Farms, Wis.

d. Identification: Eartag.

Management

a. Feeding method: pre-partum: ˜3 kg/animal/day, half provided in the morning, half in the afternoon. Post-partum: ad-libitum (˜10-20% weighbacks each day).

b. Watering method: ad libitum from nipple waterers.

c. Housing: Farrowing crates in building 608W, inside dimensions-9.5″×6′ 11″.

d. Environmental control: Thermostatically controlled ventilation.

e. Diet: 17% protein corn+soybean meal diet, PL17.

Test Materials

CP161,258, Sigma Chemical Co, 25 mg/ml in 50% propylene glycol, lot 110K1203, Expires FEB02. Porcine Relaxin, Univ. of IL, 3000 U/mg, lot 62, Expires 06/2002. 0.9% sterile saline, Abbott Laboratories, lot 58-570-DK, Expires 01 NOV01.

Design:

| Treat- | | Number of |
|---|---|---|
| ment | Description | animals |
| T1 | Non-medicated control | 15 |
| T2 | Days 112 and 113, 4 mg/kg CP161,258, 8 AM, oral | 15 |
| T3 | Day 113, 8 mg/kg CP161,258, 8 AM, oral | 15 |
| T4 | Day 113, 1200 IU Relaxin, 8 AM, intramuscular | 15 |
| | to lower ham | |

Procedure:

Animals. Sixty pregnant crossbred female swine were purchased and delivered to Terre Haute on approximately day 102-107 of gestation. These animals were placed in gestation crates in building 608E. Groups of 20 animals were weighed and then moved into farrowing crates on approximately day 108 of gestation. This BW was used to calculate the amount of test article to administer (T2 and T3).

Diet. The same feed, PL17, which contained approximately 17% crude protein, was fed throughout the study. The amount fed was limited to approximately 3 kg/animal/day prior to farrowing. Feed was provided ad libitum after farrowing.

Randomization of animals. Animals were ranked according to expected farrowing date and then randomly assigned to treatment within blocks of 4 animals each.

Test article administration. Animals assigned to T1 did not receive test article or diluent. For treatment groups T2 and T3, test article was diluted (a suspension) to a concentration of 25 mg/ml in 50% propylene glycol and stored refrigerated (2-8° C.).

For treatment groups T2 and T3, animals were snared and test article was administered orally using a 60 ml syringe. The volume administered was approximately 30 ml to deliver a dosage of 4 mg/kg BW (T2, days 112 and 113), or 60 ml (T3, day 113) to deliver 8 mg/kg BW. One container of approximately 440 ml was mixed and used within each week of the 3 wk study. Each animal assigned to T2 or T3 also received approximately 30 ml of tap water to insure that test article was swallowed.

Porcine relaxin was diluted to a concentration of 1200 U/ml in sterile physiological saline on the first day of use. Diluted porcine relaxin was stored in a locked refrigerator and removed only when injections took place. Relaxin (1 ml-T4) was administered intramuscularly in the lower part of the ham of either leg with an 18-gauge, 1.5″ long needle attached to a 3 ml syringe.

Administration of test articles occurred between 7:30 am and 8:30 am on almost all days of the study.

Early farrowing. Any animal that started farrowing (i.e. at least one pig born) before day 112 was removed from the study.

Animals assigned to T2 that started farrowing after receiving test article on day 112, but before the time that test article would be administered on day 113 did not receive any additional test article. However, those animals remained on study and data for time of birth of piglets were collected.

Animals assigned to T3 or T4 that started farrowing before receiving test article on day 113 were removed from the study.

Failure to farrow. Any sow that did not farrow by the morning of day 117 post-breeding was removed from the study to allow placement of other animals in the farrowing crates. Despite not farrowing, a value of 120 hr (maximum duration of wait) was assigned for time from treatment to time of birth of first pig. These animals were omitted from analyses of numbers of piglets born alive, stillbirths, and mummies.

Piglets. Response variables measured in this study were: hours from the 1^{st} treatment to the birth of the 1^{st} pig, number of piglets that were alive at birth (born alive), stillborn (normal appearance term piglet, but dead at time of birth), and mummies (smaller than littermates, decayed at birth). Animals were not processed (no iron shots, no clipping of needle teeth, no individual identification), but umbilical cords were clipped to −2.5 in. length if animals could not be euthanized within 2 days after birth.

Data/Analyses. Response variables measured in this study were: hours from the time of the dosing on day 112 to the birth of the 1^{st} pig, hours from the time of dosing on day 113 to the birth of the 1^{st} pig, numbers of piglets born alive, stillborn (normal appearance term piglet, but dead at time of birth), and mummies (smaller than littermates and decayed at birth). Data were analyzed using a mixed model analysis with block as a random effect and treatment as a fixed effect (proc mixed, SAS).

Results

No adverse behavioral reactions were observed immediately after dosing for any treatment. Some or all data from 8 animals were excluded from analyses. Reasons for removal of animals or data from the study were: farrowing before receiving test article, dystocia, and failure to farrow (Table 5). The reported incidence of dystocia in swine is between 7 and 15% of all farrowings, with the highest incidence occuring in first parity gilts (Straw et al, JAVMA, 2000). The incidence of dystocia observed in this study (6%) was similar to levels observed in previous studies at Terre Haute and with published incidence. The average BW of gilts was 192 kg.

Mean time to onset of parturition from time of dosing on days 112 and 113 and piglet data for each treatment are in Table 6. Compared with non-medicated controls, administration of the progesterone receptor antagonist CP161,258 at a dosage of 4 mg/kg BW on days 112 and 113 (T2) advanced the time to onset of parturition and improved the uniformity of onset among animals. Fifty-four % (7/13) of animals that received T2-4 mg/kg CP161,258 on days 112 and 113 started farrowing on day 113, and another 31% (4/13) started on day 114. These data are in very close agreement with results observed in study 7821 P-60-01-153, in which 44% of treated animals started farrowing on day 113 and the remaining 56% of treated animals farrowed on day 114.

The number of stillborns was numerically, but not statistically, lower (0.4 pigs/litter) for T2 compared with T1-non medicated controls. The number of stillborn pigs was significantly lower (0.9 pigs/litter) in the previous study for this same treatment. The overall incidence of mummies was higher for T2 than for T1. However, this is likely pure chance: based on physical size—these piglets died in utero more than 1 month prior to parturition.

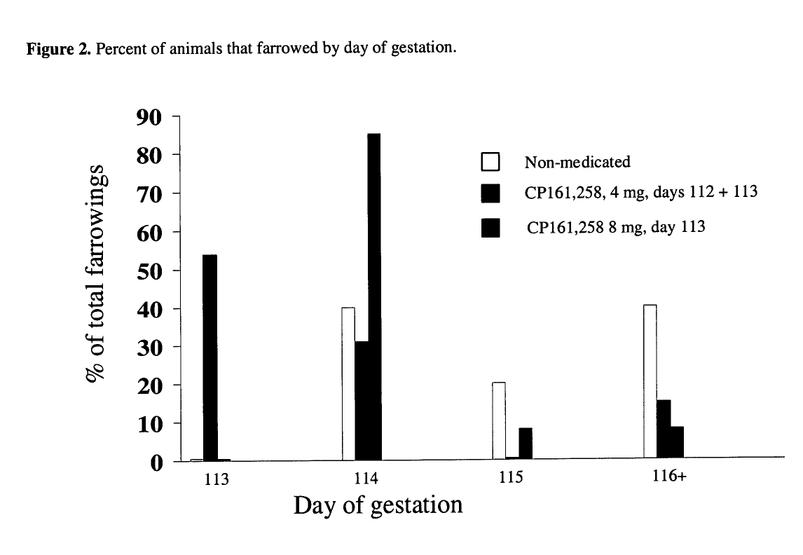

Administration of CP161,258 as a single dosage of 8 mg/kg BW on day 113 reduced the time to birth of the first pig (Table 6=means, and Table 7=individual animal data). Specifically, 40% (6/15) of animals assigned to T1-non medicated controls started farrowing on day 114. In comparison, 85% (11/13) of animals that received 8 mg/kg BW CP161,258 on day 113 started farrowing on day 114 (FIG. 2). Potential reasons that the remaining 2/13 animals assigned to T3 required longer (49 and 96 hr) to begin farrowing than the majority of other animals on T3 include: a) the oral absorption may have differed compared with other gilts that received the same treatment; b) these 2 animals may have failed to swallow all test article after it was squirted from the syringe (total volume ˜60 ml) into their mouths; or c) these 2 animals may have been less responsive to the test article, indicating the biological variability in response that can be expected among animals.

As observed for T2, the number of stillborns was reduced numerically, but not statistically (0.6 pigs/litter) for T3 compared with T1 non-medicated controls.

Administration of 1200 U porcine relaxin IM on day 113 did not have beneficial effects on time to birth of the first pig, number born alive, or stillborns (Table 6).

Conclusions

These data demonstrate that the progesterone receptor antagonist CP161,258 improved synchrony of onset of parturition: 70% farrowed 24 to 27 hr post-dosing, and 85% farrowed between 21 and 35 hr after a single dose of 8 mg/kg BW. This dose of CP161,258 numerically reduced stillborns compared with non-medicated controls (0.6 pigs/litter). Porcine relaxin was not effective.

These data suggest that a single administration of a progesterone receptor antagonist safely and effectively synchronizes parturition, lowers stillbirths, and enables supervision of most farrowings. Together, these events will significantly lower pre-weaning mortality and improve profitability of farrowing operations.

TABLE 5
Animals with incomplete data (did not meet entry
requirements or did not complete the study).

| Treatment | Animal | Reason |
|---|---|---|
| T1-Non-med | 463 | Did not farrow before day 117 |
| | | (assigned a value of 120 hr for treatment |
| | | to 1^{st} pig interval) |
| T2-CP161,258 | 440 | Dystocia |
| D 112 + 113 | | |
| T2-CP161,258 | 480 | Dystocia |
| D 112 + 113 | | |
| T3-CP161,258 | 456 | Farrowed before receiving test article |
| D 113 | | |
| T3-CP161,258 | 470 | Farrowed before receiving test article |
| D 113 | | |
| T4-Relaxin | 441 | Dystocia (born alive, stillborns, mummy count |
| | | incomplete) |
| T4-Relaxin | 488 | Dystocia-(born alive, stillborns, mummy count |
| | | incomplete) |
| T4-Relaxin | 448 | Farrowed before receiving test article |

TABLE 6
Farrowing data by treatment. Number of data points is in parentheses
beside each mean. (Means for T2, T3, and T4 within each row were
compared with T1. Other comparisons were irrelevant.
SD = standard deviation; CL = 95% confidence limits).

| | T1- | T2-4 mg/kg BW | T3-8 mg/kg BW | | | Overall |
|---|---|---|---|---|---|---|
| | Non- | CP161,258 | CP161,258 | T4-1200 U | Avg | Treatmt |
| | medicated | D 112 + 113 | D 113 | pRelaxin | SE | P< |
| Hr, Dose d 112 | (day 112) | (day 112) | (day 113) | (day 113) | 7.0 | P = .0004 |
| To 1^{st} pig ± SD | 77 ± 31 (15) | 45 ± 26^{a} (13) | 33 ± 20 (13) | 56 ± 26 (13) | | |
| Lower/upper CL | 64/91 | 30/59 | 18/48 | 41/70 | | |
| Hr, Dose d 113 | (day 113) | (day 112) | (day 113) | (day 113) | 7.0 | P = .1099 |
| To 1^{st} pig ± SD | 53 ± 31 (15) | 45 ± 26^{b} (13) | 33 ± 20^{c} (13) | 56 ± 26^{d} (13) | | |
| Lower/upper CL | 40/67 | 30/59 | 18/48 | 41/70 | | |
| Piglet data: | | | | | | |
| Born alive | 7.9 (14) | 9.2 (13) | 8.6 (13) | 6.4 (12) | 1.0 | P = .08 |
| Stillborn | 1.1 (14) | 0.7 (13) | 0.5 (13) | 1.6 (12) | 0.3 | P = .11 |
| Mummies | 0 (14) | 0.4* (13) | 0.2 (13) | 0.3 (12) | 0.13 | P = .18 |

^{a}Pairwise comparison T1 vs T2 P < .001. Other comparisons not meaningful because test articles were administered on day 113 for T3.
^{b}Pairwise comparison T1 vs T2 P < .38
^{c}Pairwise comparison T1 vs T3 P < .04
^{d}Pairwise comparison T1 vs T4 P < .77

TABLE 7
Response variables for each animal.
(“.” = missing data-did not farrow or incomplete
farrowing due to dystocia).

| | | Hr, 1^{st} | | | |
|---|---|---|---|---|---|
| | | treatment | | | |
| Animal | Treatment | to 1^{st} pig | Born Alive | Still-born | Mummies |
| 439 | 1 | 46.3 | 13 | 0 | 0 |
| 449 | 1 | 46.7 | 5 | 3 | 0 |
| 494 | 1 | 47.3 | 8 | 5 | 0 |
| 471 | 1 | 51.8 | 4 | 0 | 0 |
| 472 | 1 | 53.7 | 12 | 0 | 0 |
| 482 | 1 | 57.8 | 5 | 0 | 0 |
| 452 | 1 | 61 | 11 | 0 | 0 |
| 444 | 1 | 70.2 | 10 | 2 | 0 |
| 467 | 1 | 70.5 | 7 | 0 | 0 |
| 442 | 1 | 75.6 | 5 | 1 | 0 |
| 490 | 1 | 82.5 | 7 | 0 | 0 |
| 457 | 1 | 118.4 | 11 | 3 | 0 |
| 484 | 1 | 119 | 4 | 1 | 0 |
| 463 | 1 | 120 | . | . | . |
| 477 | 1 | 136.2 | 9 | 0 | 0 |
| 450 | 2 | 22.5 | 8 | 1 | 0 |
| 438 | 2 | 24.5 | 13 | 1 | 0 |
| 489 | 2 | 26.4 | 10 | 0 | 2 |
| 468 | 2 | 28.6 | 9 | 1 | 1 |
| 493 | 2 | 28.9 | 7 | 0 | 1 |
| 479 | 2 | 32.1 | 9 | 1 | 0 |
| 466 | 2 | 33.6 | 10 | 1 | 0 |
| 485 | 2 | 45.7 | 10 | 0 | 0 |
| 460 | 2 | 46 | 2 | 1 | 0 |
| 446 | 2 | 46.3 | 12 | 1 | 0 |
| 475 | 2 | 49.1 | 6 | 1 | 0 |
| 459 | 2 | 96.3 | 13 | 1 | 0 |
| 453 | 2 | 101 | 11 | 0 | 1 |
| 461 | 3 | 21.2 | 6 | 0 | 0 |
| 491 | 3 | 23.7 | 13 | 0 | 1 |
| 481 | 3 | 24.4 | 12 | 0 | 0 |
| 465 | 3 | 24.5 | 6 | 2 | 1 |
| 486 | 3 | 24.7 | 10 | 0 | 0 |
| 447 | 3 | 25.1 | 7 | 1 | 0 |
| 474 | 3 | 25.2 | 10 | 0 | 1 |
| 476 | 3 | 25.3 | 10 | 0 | 0 |
| 443 | 3 | 26.3 | 14 | 1 | 0 |
| 436 | 3 | 27.1 | 11 | 0 | 0 |
| 492 | 3 | 34.4 | 4 | 0 | 0 |
| 454 | 3 | 49 | 6 | 2 | 0 |
| 451 | 3 | 93.8 | 3 | 1 | 0 |
| 464 | 4 | 10.9 | 6 | 5 | 2 |
| 445 | 4 | 25.3 | 3 | 0 | 0 |
| 487 | 4 | 34.2 | 8 | 1 | 0 |
| 495 | 4 | 47.4 | 4 | 2 | 0 |
| 483 | 4 | 48.5 | 9 | 1 | 1 |
| 469 | 4 | 49.2 | 1 | 0 | 0 |
| 478 | 4 | 49.7 | 14 | 2 | 0 |
| 462 | 4 | 51 | 4 | 1 | 0 |
| 441 | 4 | 69.9 | . | . | . |
| 437 | 4 | 74.9 | 6 | 2 | 0 |
| 455 | 4 | 77.2 | 6 | 1 | 0 |
| 458 | 4 | 82.4 | 9 | 2 | 0 |
| 473 | 4 | 106.3 | 7 | 2 | 0 |

What is claimed is:

1. A method of inducing parturition in pregnant swine that will result in birth of a first piglet within a predictable number of hours, wherein said method reduces the incidence of stillborn piglets, said method comprising administering a progesterone receptor antagonist to pregnant swine that are at least 112 days post-breeding.

2. The method of claim 1, wherein said predictable number of hours is about 12 to about 22 hours.

3. The method of claim 1, wherein said progesterone receptor antagonist is selected from the group consisting of RU38486, ZK230211, ZK98299, ZK98774, ZK137316, ZK112993, J867, J956, LGOO1447, LG120753, 0RG33628, mifepristone, onapristone, and lilopristone and combinations thereof.

4. The method of claim 1, wherein said progesterone receptor antagonist is RU38486.

5. The method of claim 1, wherein said progesterone receptor antagonist is administered via a single administration.

6. The method of claim 1, wherein said progesterone receptor antagonist is administered via at least two administrations.

7. The method of claim 5, wherein said progesterone receptor antagonist in said single administration is in the amount of about 0.001 to about 15 mg/kg body weight.

8. The method of claim 5, wherein said progesterone receptor antagonist in said single administration is in the amount of about 8 mg/kg body weight.

9. The method of claim 5, wherein said single administration is done at approximately 20-25 hours prior to the birth of a first piglet.

10. The method of claim 6, wherein said progesterone receptor antagonist is administered in the amount of about 0.001 to about 15 mg/kg body weight per administration.

11. The method of claim 6, wherein said progesterone receptor antagonist is administered in the amount of about 4 mg/kg body weight per administration.

12. The method of claim 6, wherein said progesterone receptor antagonist is administered via two administrations, wherein the first administration is performed at approximately 30-40 hours prior to the birth of a first piglet, and the second administration is performed at approximately 9 to 15 hours prior to the birth of a first piglet.

13. The method of claim 1, wherein said progesterone receptor antagonist is administered intramuscularly, intravenously, subcutaneously, intravaginally or orally.

14. The method of claim 13, wherein said progesterone receptor antagonist is administered with a pharmaceutically acceptable carrier.

15. A method of inducing parturition in pregnant swine that will result in birth of a first piglet within a predictable number of hours, wherein said method reduces the incidence of stillborn piglets, said method comprising administering RU38486 in a single administration to pregnant swine that are at least 112 days post-breeding.
